(19) United States
(12) Patent Application Publication
(10) Pub. No.: US 2026/0257162 A1
(43) Pub. Date: Sep. 3, 2026

(54) FILTER ELEMENT AND FILTER DEVICE

(71) Applicant: MANN+HUMMEL GmbH, Ludwigsburg (DE)

(72) Inventors: Pascal NEEF, Trossingen (DE); Michael KAUFMANN, Meckenheim (DE); Klaus-Dieter RUHLAND, Meckenheim (DE)

(21) Appl. No.: 19/649,589

(22) Filed: Apr. 16, 2026

Related U.S. Application Data
(63) Continuation of application No. PCT/EP2024/079762, filed on Oct. 22, 2024.

(30) Foreign Application Priority Data
Oct. 23, 2023 (DE) 10 2023 129 015.0

(51) Int. Cl. B01D 46/24

(52) U.S. Cl. CPC B01D 46/2403; B01D 2201/34; B01D 2275/206

(57) ABSTRACT

A filter element for filtering fluid has a filter bellows arranged around a longitudinal axis and enclosing an interior. The filter bellows has a first end and an opposed second end. The filter bellows has a first end plate open toward the interior at the first end and a second end plate at the second end. A circumferential seal contour is arranged at the first end plate and rises (extends) in the longitudinal direction from the first end plate. The circumferential seal contour has a locally limited recess in radial direction and protrudes in a region of the locally limited recess inwardly past an inner circumference of the filter bellows. A filter device has a filter housing with fluid inlet, fluid outlet, and a receiving space accommodating the filter element such that a raw side at the fluid inlet is separated from a clean side at the fluid outlet.

### CROSS REFERENCE TO RELATED APPLICATIONS

This application is a continuation application of international application No. PCT/EP2024/079762 having an international filing date of Oct. 22, 2024, and designating the United States, the international application claiming a priority date of Oct. 23, 2023, based on prior filed German patent application No. 10 2023 129 015.0, the entire contents of the aforesaid applications being incorporated herein by reference to the fullest extent permissible.

### BACKGROUND

The present invention concerns a filter element for filtering a fluid, for example an air filter element for an air filter system, for example for an intake air filter system of a fuel cell or internal combustion engine. Furthermore, the invention concerns a filter device with such a filter element.

The intake air of fuel cells and/or internal combustion engines is usually purified prior to entering a cathode space or combustion chamber by means of an air filter from particulate and/or gaseous contaminants, for which purpose air filter elements are used. Further, the air flowing into a vehicle cabin is nowadays also freed as completely as possible from contaminants. Possibly occurring contaminants are, for example, particulate matter, pollen, soot or aerosols.

In general, filter element or filter insert is understood as device components which, exchangeable as a unit, may be arranged in a filter housing and which include at least one filter medium body of a filter medium, frequently in the form of a folded filter bellows, and usually also a structure supporting or carrying the filter medium, and usually a seal. The respective filter medium usually includes a limited service life for which reason filter elements must be exchanged regularly.

Such filter elements or filter inserts are frequently embodied as so-called round elements which include a filter bellows arranged around a longitudinal axis and enclosing an interior at least partially. The filter bellows may be delimited at a first end face end by an open end plate and at a second end face end opposite the first end face end by a further end plate, for example a closed end plate. Frequently, a circumferential seal is arranged at the open end plate.

For various reasons, it may be technically required in this context that round filter elements are inserted in a predetermined installation position in a filter housing. For example, in the aforementioned applications, volume and/or mass flow sensors are frequently used which measure an intake air quantity. Such volume and/or mass flow sensors are in general calibrated in respect to a certain installation position of the round filter element so that measuring imprecisions occur in case of an installation of the round filter element in the filter housing deviating from the predetermined installation position. The reason for this is that the filter medium body in general has a seam location which affects the flow profile at the outflow side.

WO 2019/219635 A1 discloses a round filter element which includes a circumferentially extending filter bellows which is delimited at its respective ends by an end plate, wherein at least one of the end plates is an open end plate. The filter bellows includes, for example, a star-shaped folded filter medium and includes at its end which is close to the open end plate a spread-apart portion at the outer circumference, wherein the spread-apart portion extends only across a portion of the total length of the filter bellows. The spread-apart portion of the filter bellows is aligned with a corresponding cut at an outer circumference of the open end plate. At the open end plate, a circumferentially extending seal is furthermore arranged which extends in a circular shape radially inside of the cut. Furthermore, a filter housing for receiving the round filter element is disclosed therein that in an interior includes a notch which engages in a mounted state the spread-apart portion of the filter bellows of the round filter element in order to position the round filter element in regard to an angular position in relation to the filter housing.

A disadvantage in this context is that the seal contour extends on a comparatively small diameter which is detrimental to an optimal sealing action. Furthermore, the therein proposed system is prone to misuse since any type of filter element may be installed in the filter housing, for example, after the housing-side notch has been removed.

Moreover, WO 2018/073198 A1 discloses a further filter element that includes a spread-apart portion at an outer circumference of a filter bellows, wherein the filter bellows includes an elongate oval cross-sectional shape. The filter bellows is delimited at its respective ends by an end plate, wherein one of the end plates is an open end plate. The filter element is for example configured to be flowed through radially from the interior to the exterior and includes at its outer circumference a grid structure which supports the filter bellows. At the grid structure, a circumferentially extending radially projecting seal carrier is provided which supports an axial seal, wherein the seal carrier is spaced apart from the open end plate in axial direction. The grid structure includes furthermore a radially inwardly projecting positioning element that supports the spread-apart portion and is open in radially outward direction as well as axially toward the side of the open end plate so that a blade provided at a filter housing may engage the positioning element.

### SUMMARY

In view of this background, the present invention has the object to provide a filter element which enables forcing an unequivocal installation position in a filter housing.

This object is solved by a filter element for filtering a fluid, for example an air filter element for an air filter system, for example for an intake air filter system of a fuel cell or internal combustion engine, including a filter bellows arranged around a longitudinal axis and enclosing an interior at least partially, wherein the filter bellows includes an end face first end and an oppositely positioned end face second end, and an end plate open toward the interior at the first end and a further end plate, for example closed end plate, at the oppositely positioned second end, wherein at the end plate open toward the interior at least one circumferential seal contour is arranged which rises (extends) in the direction of the longitudinal axis from the end plate open toward the interior, wherein the circumferential seal contour includes a locally limited recess in relation to a radial direction, wherein the circumferential seal contour in the region of the locally limited recess protrudes radially inwardly past an inner circumference of the filter bellows.

This object is solved furthermore by a filter device including a filter housing with a fluid inlet and a fluid outlet as well as a receiving space for a filter element, in which a filter element is arranged such that it separates a raw side correlated with the fluid inlet from a clean side correlated with the fluid outlet, wherein the filter element is a filter element according to the invention.

Embodiments of the invention are described in the following and illustrated in the accompanying drawings.

A first aspect of the present invention concerns a filter element which is configured for filtering a fluid and for example may be an air filter element for an air filter system, for example for an intake air filter system of a fuel cell or an internal combustion engine. However, it is in principle also possible that the filter element according to the invention may be a liquid filter element.

According to an embodiment, the filter element according to the invention includes a filter bellows which is arranged around a longitudinal axis and which surrounds at least partially an interior, wherein the filter bellows includes an end face first end and an oppositely positioned end face second end. Furthermore, the filter element includes an end plate open toward the interior at the first end and a further end plate, for example a closed end plate, at the oppositely positioned second end. At the end plate open toward the interior, at least one circumferential seal contour is arranged which rises (extends) in the direction of the longitudinal axis from the end plate open toward the interior. The circumferential seal contour includes a locally limited recess in relation to a radial direction, wherein the circumferential seal contour in the region of the locally limited recess protrudes radially inwardly past an inner circumference of the filter bellows.

In other words, in the region of the locally limited recess, the seal contour is recessed inwardly in comparison to the course of the seal contour along a major portion of its circumference in such a way that it protrudes into a cross section of the interior in relation to the radial direction. The at least one locally limited recess may have for example an extension around a circumference of the circumferential seal contour which lies in a range of 1° to 30° of the entire circumference, for example 5° to 20° of the entire circumference.

Herein, “first end” and “second end” refer to ends of the filter bellows which are facing away from each other in relation to the longitudinal axis.

The term “filter bellows” encompasses in its broadest meaning any type of filter medium body including at least one filter medium which may be present in a folded or non-folded form. The filter medium may be for example a particle filter medium or gas filter medium. Optionally, the filter medium may include at least one adsorber, for example active carbon. A filter medium which is embodied as a particle filter medium, may include for example a nonwoven material, for example of synthetic fibers and/or cellulose fibers.

The filter bellows may be flowed through for example in radial direction, for example radially from the exterior to the interior so that a clean side may be present for example in the region of the interior enclosed by the filter bellows. In embodiments however, a flow radially from the interior to the exterior is also possible so that a raw side may be present in the region of the interior enclosed by the filter bellows.

The filter element according to the invention is for example a round filter element. The filter bellows may include, for example, a closed cross section. A cross-sectional shape of the filter medium body may be selected, for example, from the group including circular, oval, elongate oval, and kidney-shaped.

The filter bellows may include for example the shape of a straight or oblique prism, wherein the first and second ends form the respective base and cover surfaces of the prism. For example, the filter bellows may have a hollow cylindrical shape.

The filter bellows may for example surround the interior completely in circumferential direction, wherein during manufacture initially free circumferential ends (in case of folded filter bellows: the so-called “end folds”) may be connected to each other in order to form a circumferentially “endless” filter bellows. In embodiments, it is however also possible that, during the manufacture, between the initially free circumferential ends an adapter part may be arranged which connects the initially free circumferential ends to each other.

As an alternative or in addition, the filter bellows may also widen in the direction of the longitudinal axis from the first end in the direction toward the second end or in reverse so that a conical shape results as a whole, for example. The filter element according to the invention is characterized by an asymmetric structure of the circumferential seal contour in relation to the longitudinal axis which enables a mandatory angular orientation of the filter element in relation to a filter housing so that the possibilities for improperly inserting the filter element into a filter housing in an angular position deviating from the predetermined position are significantly reduced.

According to a further embodiment, the filter bellows may include a plurality of folds whose radially outer fold edges are positioned at an outer wall surface and whose radially inner fold edges are positioned at an inner wall surface.

The folds of the filter bellows may be for example in the form of star-shaped folds, wherein the folds for example may have a constant cross-sectional shape across a major portion of the circumference. The plurality of folds may be present as V folds with fold heights that stay the same across the circumference. As an alternative, the plurality of folds may also be present as so-called W folds with intermediate folds of a reduced fold height.

According to a further embodiment, the circumferential seal contour in the region of the locally limited recess may extend radially inside an inner wall surface of the filter bellows which adjoins the interior. In other words, the locally limited recess of the circumferential seal contour protrudes farther radially inwardly than a circumferential contour along which the inner wall surface of the filter bellows extends.

For example, the locally limited recess of the circumferential seal contour protrudes farther inwardly than a surface section of the inner wall surface of the filter bellows which is present at the angular position at which the locally limited recess of the circumferential seal contour is arranged.

According to an embodiment, a fluid-permeable support grid may be arranged in the interior, wherein the support grid supports for example the filter bellows at the inner wall surface.

The support grid may be, for example, designed as a support tube which includes a plurality of openings. The support tube may include a plurality of stays which extend for example in circumferential direction and/or longitudinal direction, wherein the filter bellows may be supported with its inner wall surface at the stays.

In an embodiment, the support grid may include an end section at an end which is close to the first end of the filter bellows and which supports the circumferential seal contour in the region of the locally limited recess, wherein for example the end section is embedded in the circumferential seal contour in the region of the locally limited recess.

The end section of the support grid supports the circumferential seal contour in the region of the locally limited recess, for example at a side of the circumferential seal contour which is facing the interior in relation to the axial direction. Since the seal contour in the region of the locally limited recess is not stabilized by the filter bellows, because in this region it protrudes past an inner circumference of the filter bellows, a support action by the support grid in the region of the locally limited recess provides an improved stiffness of the circumferential seal.

In embodiments, it may be provided that the support grid includes at least a locally limited bulge in relation to the radial direction which protrudes into the interior, wherein the locally limited bulge of the support grid is circumferentially arranged such that its position corresponds to a circumferential position of the locally limited recess of the circumferential seal contour, wherein for example the bulge protrudes farther into the interior than a major portion of the circumference of the support grid.

In other words, the bulge of the support grid is arranged at a circumferential position at which also the recess of the seal contour is present. Expressed still differently, a circumferential position of a local maximum of a deviation of the seal contour from its basic shape in the region of the recess may coincide with a circumferential position, viewed in radial direction, of a lowest point of the bulge. Smaller angular deviations between the circumferential position of the recess of the seal contour and of the bulge of the support grid are however possible so that, for example, in case of an alignment error of up to 20°, for example up to 15°, one may still speak of a “corresponding arrangement”. Such smaller alignment errors are often unavoidable due to tolerances caused in production.

The bulge of the support grid may extend across the complete length of the support grid. As an alternative, the bulge may also be present only at an end of the support grid which is close to the first end of the filter bellows.

According to an embodiment, a region lying radially outside of the locally limited recess of the circumferential seal contour may be sealed in relation to the open end plate and/or the filter bellows, wherein for example the region lying radially outside of the locally limited recess of the circumferential seal contour is closed by an end wall which is for example one piece together with the open end plate.

The sealing action of the region lying radially outside of the locally limited recess of the circumferential seal contour in relation to the open end plate is advantageous in order to avoid leaks and thus undesirable bypass flows bypassing the filter bellows so that it is ensured that the circumferential seal contour fulfills its technical main function of a sealing action between raw side and clean side. The end wall which is formed as one piece together with the open end plate may be produced for example in the same manufacturing step as the open end plate, wherein for example it may be provided that the end wall together with the open end plate is produced in a casting or injection molding process.

According to a further embodiment, the end plate open toward the interior may include at least one aperture in the region of the locally limited recess, the aperture extending with an axial component through the end plate open toward the interior, wherein the aperture for example connects the interior in fluid communication to an external space lying axially outside of the open end plate.

The aperture may include for example a coherently closed cross-sectional shape and/or a bore-type structure.

The aperture may be present for example at the circumferential seal contour and extend with an axial component through the circumferential seal contour, wherein the aperture for example connects the interior in fluid communication to an external space lying axially outside of the circumferential seal contour.

The aperture may extend for example from an end face of the circumferential seal completely through a material of the circumferential seal so that the aperture provides a fluid channel which connects the interior to an external space adjacent to the end face of the circumferential seal.

As an alternative or in addition, an aperture may be present at the end wall and extend with an axial component through the end wall, wherein the aperture for example connects the interior in fluid communication to an external space arranged radially outside of the end wall. This embodiment has the advantage that the circumferential seal contour is not mechanically weakened by an aperture.

In this context, the aperture may be arranged inside or outside of a cross section of the filter bellows. For example, the aperture may be radially arranged such that it is present lying radially inwardly in relation to the inner wall surface of the filter bellows. As an alternative, it is also possible that the aperture is present within a bellows cross section so that it is present for example between neighboring folds of the filter bellows.

In both variants of the aperture, the aperture may be closed in a mounted state of the filter element in a filter housing by an accurately fitting housing projection which at least in sections dips into the aperture. For example, it is possible in this context to tap a pressure in the interior of the filter element through the fluid channel provided by the aperture in order to measure the pressure by means of a pressure measuring device.

According to an embodiment, the filter bellows may include at its outer circumference and/or inner circumference at least one notch, wherein the notch in circumferential direction is arranged such that its position corresponds to a circumferential position of the locally limited recess of the circumferential seal contour.

In other words, the notch of the filter bellows is arranged at a circumferential position at which also the recess of the seal contour is present. Still expressed differently, a circumferential position of a local maximum of a deviation of the seal contour from its basic shape in the region of the recess may coincide with a circumferential position of a lowermost point of the notch, viewed in radial direction. Smaller angular deviations between the circumferential position of the recess of the seal contour and the notch of the filter bellows are however possible so that, for example, in case of an alignment error of up to 20°, for example up to 15°, one may still speak of a “corresponding arrangement”. Such smaller alignment errors are often unavoidable due to tolerances caused in production.

For example, the notch may be formed by a spread-apart portion of at least one fold of the filter bellows at the inner and/or outer circumference.

In the region of the notch provided by the spread-apart portion at the inner and/or outer circumference, at least one fold is widened. “Widened” is to be understood for example such that a distance of fold edges adjoining a fold bottom or a fold top is enlarged in relation to neighboring folds.

In embodiments, the notch may be present at least at the first end of the filter bellows. This means that the notch is present at least at the end of the filter bellows at which the end plate which is open toward the interior is arranged.

In this context, it is either possible that the notch extends in the direction of the longitudinal axis across a total extension of the filter bellows or that the notch in the direction of the longitudinal axis is shorter than the total extension of the filter bellows and for example is present only in a longitudinal portion of the filter bellows which is close to the first end.

In embodiments in which the notch is formed by a spread-apart portion of at least one fold of the filter bellows at the inner circumference and/or outer circumference, the spread-apart portion may be present for example only in a longitudinal portion of the filter bellows close to the first end, wherein, for example in a longitudinal portion of the filter bellows remote from the first end, the spread-apart portion reverts to a uniform fold shape which corresponds to that of the plurality of the folds of the filter bellows.

In embodiments, a notch at the inner circumference of the filter bellows may be arranged circumferentially such that its position corresponds to the circumferential position of an aperture of the end wall. In other words, the notch at the inner circumference of the filter bellows may be arranged at a circumferential position at which also the aperture of the end wall is present. In this way, it is made possible that, in a mounted state of the filter element in a filter housing, a housing projection passes through the aperture of the end wall and may be received in the notch at the inner circumference of the filter bellows or inside a cross section of the filter bellows.

According to a further embodiment, the end plate open toward the interior may include at least one cut which corresponds to the notch at the filter bellows and is aligned with the at least one notch.

The cut, in case of a notch at the outer circumference of the filter bellows, may be present for example at an outer circumference of the end plate open toward the interior and extend with a radial component inwardly.

The cut penetrates a material of the open end plate. The term “cut” serves only as a means for describing the structure of this device component and does not imply a certain manufacturing type; for example, the term is not to be understood as being limited to a “cutting” manufacture.

The cut which corresponds to the notch of the filter bellows “being aligned” with the at least one notch means herein for example that a positioning of the cut in circumferential direction corresponds to a positioning of the notch of the filter bellows in circumferential direction. In other words, the cut is arranged at a circumferential position at which also the notch of the filter bellows is present. Still expressed differently, a circumferential position of a lowermost position of the cut, viewed in radial direction, may coincide with a circumferential position of a lowermost position, viewed in radial direction, of the notch. Smaller angular deviations between the circumferential position of the cut of the open end plate and the notch of the filter bellows are however possible so that, for example, in case of an alignment error of up to 20°, for example up to 15°, one may still speak of a “corresponding arrangement”. Such smaller alignment errors are often unavoidable due to tolerances caused in production.

In embodiments, the circumferential seal contour may have a predetermined basic shape, wherein a circumferential extension of the circumferential seal contour in the region of the locally limited recess deviates from the predetermined basic shape.

For example, the circumferential seal contour in the region of the locally limited recess may have a smaller radius of curvature than in sections without recess. In the region of the locally limited recess, the seal contour may extend on a smaller diameter than in sections without recess. The circumferential seal contour may include in the region of the locally limited recess for example an arc-shaped, for example circular arc-shaped, extension whose radius of curvature is smaller than a radius of curvature of an arc-shaped, for example circular arc-shaped, course in the region without recess. The sign of the curvature in the region of the locally limited recess may be different from circumferentially neighboring regions of the circumferential seal contour without recess.

The predetermined basic shape may be for example a circular shape. However, other basic shapes are also possible such as, for example, an oval or flatly oval shape. “Basic shape” is understood as the course of the seal contour in a plane of the first end of the filter bellows, respectively, in a plane of the end plate open toward the interior in circumferential sections without recess.

In embodiments, the end plate open toward the interior may include or be included of a plastic material, for example a foamed plastic material, for example a polyurethane foam, wherein for example the circumferential seal contour is one piece together with the end plate open toward the interior. The end plate open toward the interior may be connected to the first end of the filter bellows, for example materially fused, for example welded, glued or foamed on.

The circumferential seal contour together with the end plate open toward the interior may be produced in a casting process by using a foamable and flowable plastic material so that the provision of the recess of the seal contour incurs no additional expenditure for the manufacture.

Finally, according to a further embodiment, the circumferential seal contour may include at least one circumferential radial seal surface, for example at an inner circumference.

As an alternative, the circumferential seal contour may include also more than two radial seal surfaces, for example, a first radial seal surface at the inner circumference and a second radial seal surface at the outer circumference. As an alternative or in addition, it is possible that the circumferential seal contour includes at least one axial seal surface, for example at an end face of the circumferential seal contour. The seal contour may include a predetermined seal profile (radial section) which may include one or a plurality of seal strands, for example extending parallel to each other. The present invention is, however, explicitly not limited to a certain action direction of the sealing action and/or certain seal profiles. Instead, any type of seal profiles considered suitable by a person of skill in the art may be used.

A second aspect of the present invention concerns a filter device including a filter housing with a fluid inlet and a fluid outlet as well as with a receiving space for a filter element in which a filter element according to the first aspect of the present invention is arranged such that the filter element separates a raw side correlated with the fluid inlet from a clean side correlated with the fluid outlet.

The filter device may be for example an air filter device, for example an intake air filter device of a fuel cell or an internal combustion engine or a cabin air filter device. The filter housing may be for example an air filter housing.

According to an embodiment, the filter housing may include at least one circumferential housing seal surface at which the circumferential seal contour of the filter element is resting, wherein the housing seal surface includes at least a locally limited recess which corresponds to the at least one locally limited recess of the circumferential seal contour of the filter element.

The filter housing may be for example of a two-part configuration and include a housing pot in which the receiving space is present as well as a housing cover which is connected or connectable releasably to the housing pot. The housing seal surface in this context may be provided either at the housing pot or at the housing cover.

The interaction between the housing seal surface and the circumferential seal contour of the filter element provides in this context the functional main interface between the filter housing and the filter element. The main interface may fulfill its main function, namely sealing of the raw side relative to the clean side, only when the housing seal surface matches the structure of the circumferential seal contour of the filter element, wherein for example the housing seal surface at least in sections may have the design of a negative mold of the seal contour of the filter element.

Since the housing seal surface as well as the circumferential seal contour of the filter element are not rotationally symmetrical in relation to the longitudinal axis, an installation position of the filter element in the filter housing predetermined in relation to the longitudinal axis may be already reliably forced by an interaction of filter element and filter housing at the main interface.

According to a further embodiment, the end plate open toward the interior in the region of the locally limited recess may include at least one aperture which extends with an axial component through the end plate open toward the interior, wherein the aperture for example connects the interior in fluid communication to an external space which is lying axially outside of the open end plate. The filter housing includes in this context at least one housing projection protruding into the receiving space which is received in the aperture of the open end plate.

Due to the combination of a housing seal surface with at least one locally limited recess, at which the circumferential seal contour of the filter element is resting, and a housing projection, which is received in the aperture of the open end plate of the filter element, the installation position of the filter element predetermined in relation to the longitudinal axis may be forced in a best possible manner, whereby improper uses of the filter device are substantially prevented.

The housing projection may extend for example completely through the aperture of the open end plate. In this context, the housing projection, depending on the position of the aperture of the open end plate, may project radially within the inner circumference of the filter element into the interior or be received in a notch which is provided at the inner circumference of the filter bellows, wherein the notch in this context is formed for example by a spread-apart portion of at least one fold of the filter bellows at the inner circumference.

Finally, the protruding housing projection at least in sections may be hollow and may be embodied as part of a pressure measuring device, wherein by means of the protruding housing projection a pressure within the interior of the filter element may be tapped. For example, the housing projection which is hollow at least in sections may form a part of a pressure measuring conduit of the pressure measuring device.

It is understood that features, feature combinations, as well as their specific advantages disclosed in relation to the first aspect of the present invention may be applied to the second aspect of the present invention, and vice versa.

Further possible implementations of the invention also include not explicitly mentioned combinations of features described above or in the following in relation to the embodiments. In this context, a person of skill in the art will also add individual aspects and/or features as improvements or supplements to the respective basic form of the invention.

In the following, the invention will be explained in more detail with the aid of exemplary embodiments with reference to the accompanying drawing figures.

### BRIEF DESCRIPTION OF THE DRAWINGS

FIG. 1 shows an isometric view of a filter element according to the invention according to a first embodiment.

FIG. 2 shows a longitudinal section of the filter element according to the invention according to the first embodiment.

FIG. 3 shows a plan view of the filter element according to the invention according to the first embodiment from the side of the open end plate.

FIG. 4 shows an isometric exploded view of a filter device according to the invention according to a first embodiment.

FIG. 5 shows an isometric view of the filter device according to the invention according to the first embodiment.

FIG. 6 shows a plan view of the filter device according to the invention according to the first embodiment from the side of the fluid outlet.

FIG. 7 shows a longitudinal section of the filter device according to the invention according to the first embodiment.

FIG. 8 shows a detail VIII of FIG. 7.

FIG. 9 shows a section IX-IX according to FIG. 7.

FIG. 10 shows an isometric view of a first housing part of the filter device according to the invention according to the first embodiment,

FIG. 11 shows an isometric view of a filter element according to the invention according to a second embodiment.

FIG. 12 shows a longitudinal section of the filter element according to the invention according to the second embodiment.

FIG. 13 shows a plan view of the filter element according to the invention according to the second embodiment from the side of the open end plate.

FIG. 14 shows an isometric exploded view of a filter device according to the invention according to a second embodiment.

FIG. 15 shows an isometric view of the filter device according to the invention according to the second embodiment.

FIG. 16 shows a plan view of the filter device according to the invention according to the second embodiment from the side of the fluid outlet.

FIG. 17 shows a longitudinal section of the filter device according to the invention according to the second embodiment.

FIG. 18 shows a detail XVIII of FIG. 17.

FIG. 19 shows a section XIX-XIX according to FIG. 17.

FIG. 20 shows an isometric view of a first housing part of the filter device according to the invention according to the second embodiment.

FIG. 21 shows an isometric view of a filter element according to the invention according to a third embodiment.

FIG. 22 shows a longitudinal section of the filter element according to the invention according to the third embodiment.

FIG. 23 shows a plan view of the filter element according to the invention according to the third embodiment from the side of the open end plate.

FIG. 24 shows an isometric view of a filter device according to the invention according to a third embodiment.

FIG. 25 shows an isometric view of a first housing part of the filter device according to the invention according to the third embodiment.

FIG. 26 shows a plan view of the filter device according to the invention according to the third embodiment from the side of the fluid outlet.

FIG. 27 shows a longitudinal section of the filter device according to the invention according to the third embodiment.

FIG. 28 shows a detail XXVIII of FIG. 27.

FIG. 29 shows a section XXIX-XXIX according to FIG. 27.

FIG. 30 shows an isometric view of a filter element according to the invention according to a fourth embodiment.

FIG. 31 shows a longitudinal section of the filter element according to the invention according to the fourth embodiment.

FIG. 32 shows a plan view of the filter element according to the invention according to the fourth embodiment from the side of the open end plate.

FIG. 33 shows an isometric view of a filter device according to the invention according to a fourth embodiment.

FIG. 34 shows an isometric view of a first housing part of the filter device according to the invention according to the fourth embodiment.

FIG. 35 shows a longitudinal section of the filter device according to the invention according to the fourth embodiment.

FIG. 36 shows a detail XXXVI of FIG. 35.

FIG. 37 shows a section XXXVII-XXXVII according to FIG. 35.

### DETAILED DESCRIPTION

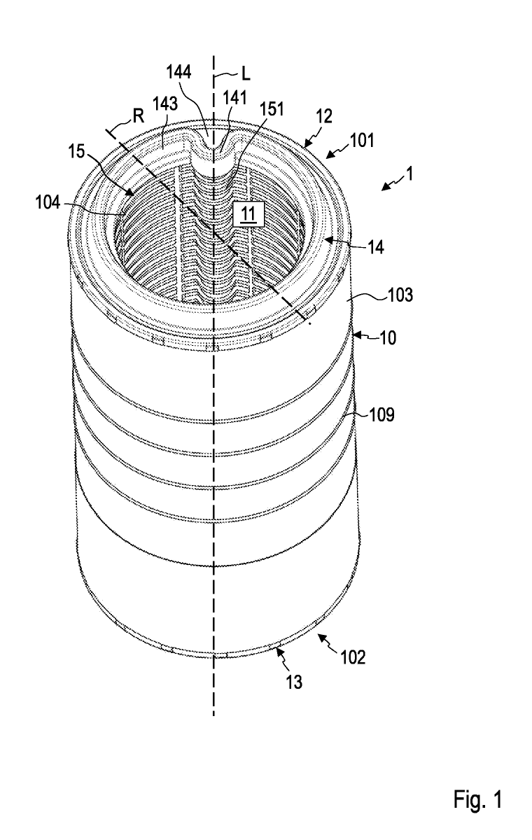

FIG. 1 shows a filter element 1 according to the invention for filtering a fluid, for example an air filter element for an air filter system, for example for an intake air filter system of a fuel cell or internal combustion engine, according to a first embodiment of the invention. The filter element is a round filter element whose filter bellows 10 comprises a hollow cylindrical shape. The filter element 1 comprises a filter bellows 10 arranged around a longitudinal axis L which encloses an interior 11. The filter bellows 10 has an end face first end 101 and an oppositely positioned end face second end 102. At the first end 101, an end plate 12 open toward the interior 11 is arranged, wherein an opening of the open end plate 12 is in fluid communication with the interior 11. At the second end 102, a further end plate 13 is arranged which is a closed end plate 13. At the end plate 12 open toward the interior 11, at least one circumferential seal contour 14 is arranged which surrounds the opening in the open end plate 12 completely circumferentially. The circumferential seal contour 14 rises (extends) in the direction of the longitudinal axis L away from the end plate 12 open toward the interior 11.

The circumferential seal contour 14 comprises a locally limited recess 141 in relation to the radial direction R. The circumferential seal contour 14 protrudes in the region of the locally limited recess 141 radially inwardly past an inner circumference 104 of the filter bellows 10. The seal contour 14 in the region of the locally limited recess 141 is offset inwardly in relation to the course along a major portion of its circumference in such a way that it protrudes into a cross section of the interior 11 in relation to the radial direction R.

At the inner circumference 104 of the filter bellows 10, a fluid-permeable support grid 15 is arranged that is configured to support the filter bellows 10 upon flow from the exterior to the interior (clean side in the interior 11) in radial direction against occurring differential pressures. The fluid-permeable support grid 15 may be embedded at the first end 101 in a material of the open end plate 12, for example enclosed in a foamed plastic material of the open end plate 12.

The support grid 15 has a locally limited bulge 151 in relation to the radial direction R which protrudes into the interior 11. The locally limited bulge 151 is arranged at the circumference such that its position corresponds to a circumferential position of the locally limited recess 141 of the circumferential seal contour 14. The bulge 151 protrudes farther into the interior 11 than a major portion of the circumference of the support grid 15. The bulge 151 of the support grid 15 extends for example across the complete length of the support grid 15.

A region which is positioned radially outside of the locally limited recess 141 of the circumferential seal contour 14 is sealed in relation to the open end plate 12, wherein for example the region which is located radially outside of the locally limited recess 141 of the circumferential seal contour 14 is closed by an end wall 144 which for example is one piece together with the open end plate 12. The end wall 141 which is formed as one piece together with the open end plate 12 may be produced for example in the same manufacturing step as the open end plate 12, wherein for example it is provided that the end wall 141 together with the open end plate 12 is produced in a casting or injection molding process. For example, the end wall 141 is not a separate device component but is a part of the open end plate 12. The end wall 144 extends for example in a region that lies between an inner circumference of the open end plate 12, along which the latter extends across a major portion of its circumference, and a radially outer side of the circumferential seal contour 14. The end wall 144 overlaps, for example a cross section of the interior 11 at least partially in relation to the radial direction R.

The basic shape of the circumferential seal contour 14 is a circle, wherein a circumferential course of the circumferential seal contour 14 in the region of the locally limited recess 141 deviates from the circular shape. The locally limited recess 141 forms a nose which projects inwardly away from the circular shape.

The open end plate 12 comprises or is comprised of a plastic material, for example a foamed plastic material, for example a polyurethane foam. The circumferential seal contour 14 is for example one piece together with the end plate 12 open toward the interior. The end plate 12 open toward the interior is connected to the first end 101 of the filter bellows 10 for example by material fusion, for example welded, glued or foamed on.

At the outer circumference 103 of the filter bellows 10, a plurality of fold stabilization means 109 are arranged which surround the filter bellows 10. The fold stabilization means 109 are spaced apart from each other in relation to the longitudinal axis L. The fold stabilization means 109 support the folds 100 of the filter bellows 10 and hold them in shape, which is for example important in case of a sudden liquid load on a filter element which is embodied as an air filter element. The fold stabilization means 109 may be, for example, strings or yarn glued to the fold tips of the filter bellows 10.

The circumferential seal contour 14 may comprise a circumferential radial seal surface 143 which is present at an inner circumference.

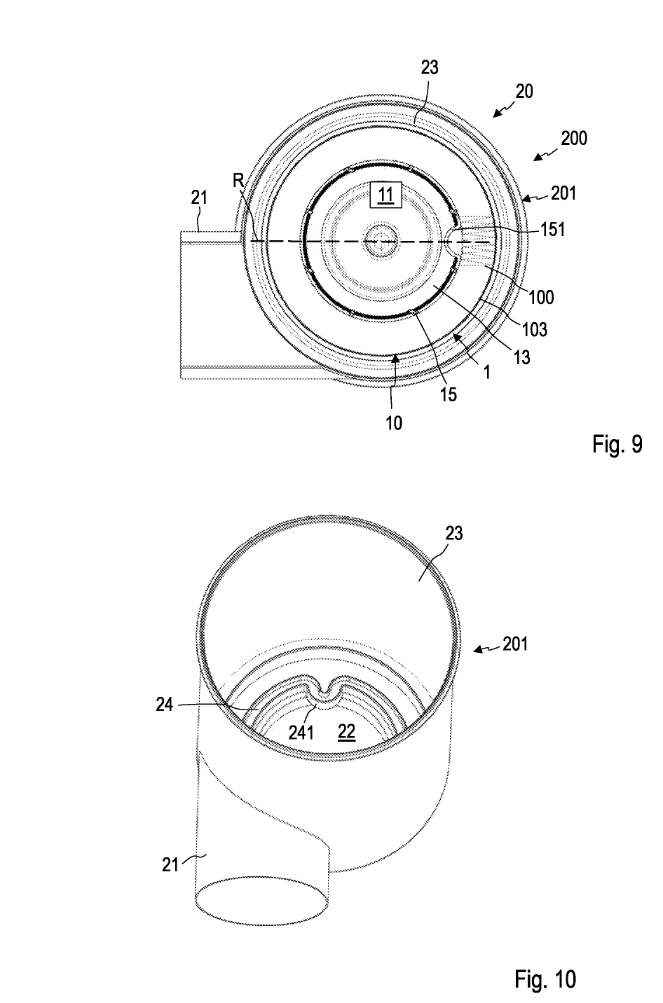

The filter bellows 10 comprises a plurality of folds 100 (see FIG. 9) whose radially outer fold edges are positioned at an outer wall surface and whose radially inner fold edges are positioned at an inner wall surface. The fold edges of the folds 100 extend, for example substantially parallel to the longitudinal axis L. The folds 100 of the filter bellows 10 have for example the form of star-shaped folds, wherein the folds extend across a major portion of the circumference of the filter bellows 100 and have a uniform cross-sectional shape.

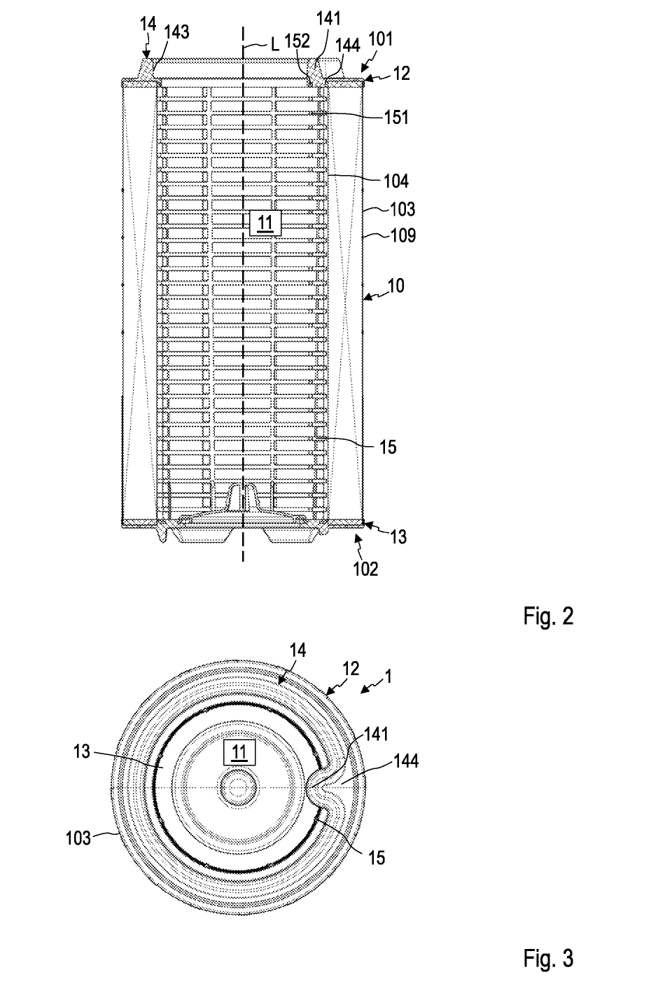

In the longitudinal section of FIG. 2, the locally limited recess 141, which protrudes radially inwardly past the inner circumference 104 of the filter bellows 10, is more precisely illustrated in relation to the radial direction R of the circumferential seal contour 14. For example this may be seen in that a spacing of the circumferential seal contour 14 from the longitudinal axis L at the right side in the illustration is smaller than at the left side in the illustration. In the region of the locally limited recess 141, the seal contour 14 extends in a region which overlaps a cross section of the interior 11 in relation to the radial direction.

Moreover, the support grid 15 comprises at an end which is close to the first end 101 of the filter bellows 10 an end section 152 which supports the circumferential seal contour 14 in the region of the locally limited recess 141, wherein the end section 152 in the region of the locally limited recess 141 is embedded in the circumferential seal contour 14. The end section 152 is configured at an end of the locally limited bulge 151 of the support grid 15 which is close to the first end 101 of the filter bellows 10. In this way, the forces, for example axial forces which are introduced in the region of the locally limited recess 141 into the seal contour 14, are transmitted to the support grid 15 so that the seal contour 14 in the region of the locally limited recess 141 is not impermissibly deformed.

FIG. 3 shows a plan view of the filter element 10 according to the first embodiment from the side of the open end plate 12, wherein the further end plate 13 which here is a closed end plate may be seen through the interior 11.

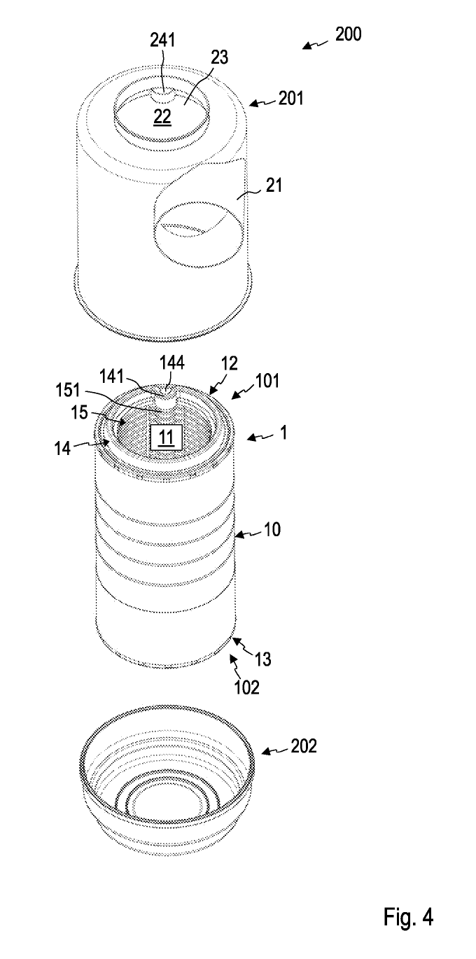

FIG. 4 shows an isometric exploded view of a filter device 200 according to the invention according to a first embodiment. The filter device 200 comprises a filter housing 20 with a fluid inlet 21 at a first housing part 201, for example a housing pot 210, and with a fluid outlet 22 at the first housing part 201. The first housing part 201 provides a receiving space 23 for a filter element 1 in which in a mounted state the filter element 1 may be arranged such that it separates a raw side correlated with the fluid inlet 21 from a clean side correlated with the fluid outlet 22.

The first housing part 201 comprises a circumferential housing seal surface 24 and the circumferential seal contour 14 of the filter element 1 may be brought into contact thereat (see FIG. 10), wherein the housing seal surface 24 comprises a locally limited recess which corresponds to the locally limited recess 141 of the circumferential seal contour 14 of the filter element 1 so that the filter element 1, in relation to its installation position around the longitudinal axis L, is positioned unequivocally in the first housing part 201. The locally limited recess of the housing seal surface 24 is arranged for example at a protrusion 241 of the first housing part 201 which at least partially protrudes in radial direction into a cross section of the fluid outlet 22. The filter housing 20 comprises furthermore a second housing part 202, for example in the form of a housing cover 202, which is connectable releasably to the first housing part 201 in order to close the receiving space 23.

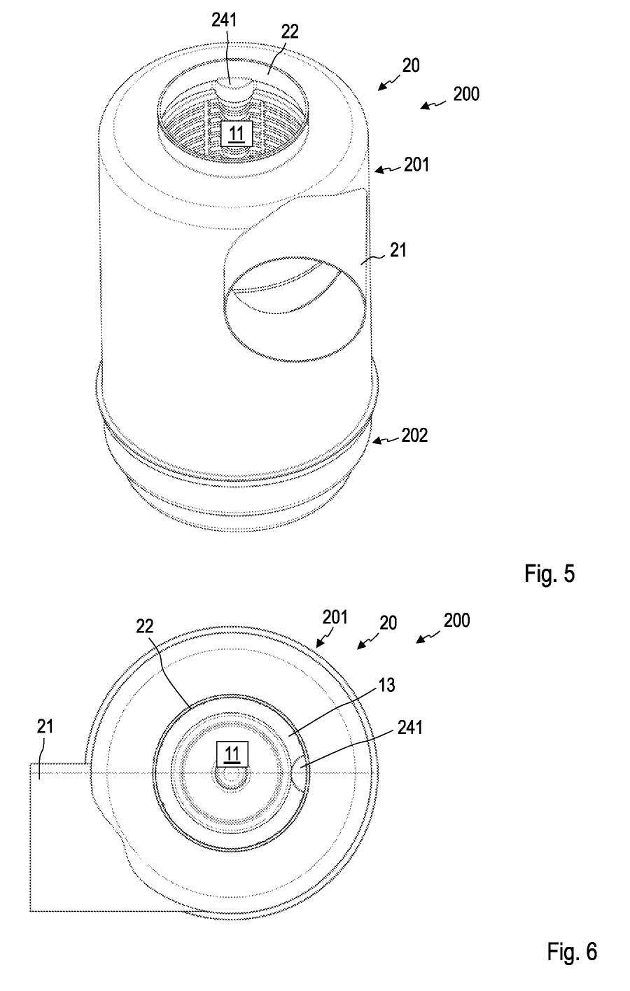

FIG. 5 shows the filter device 200 in the mounted state, i.e., with inserted filter element 1 and second housing part 202 releasably fastened to the first housing part 201.

In FIG. 6, a plan view of the filter device 200 according to the invention according to the first embodiment is illustrated from the side of the fluid outlet 22, wherein the interior 11 of the filter element 1 and its further end plate 13 may be seen through the fluid outlet 22. Furthermore, the protrusion 241 protruding into the fluid outlet 22 is illustrated at which the locally limited recess of the housing seal surface 24 is formed.

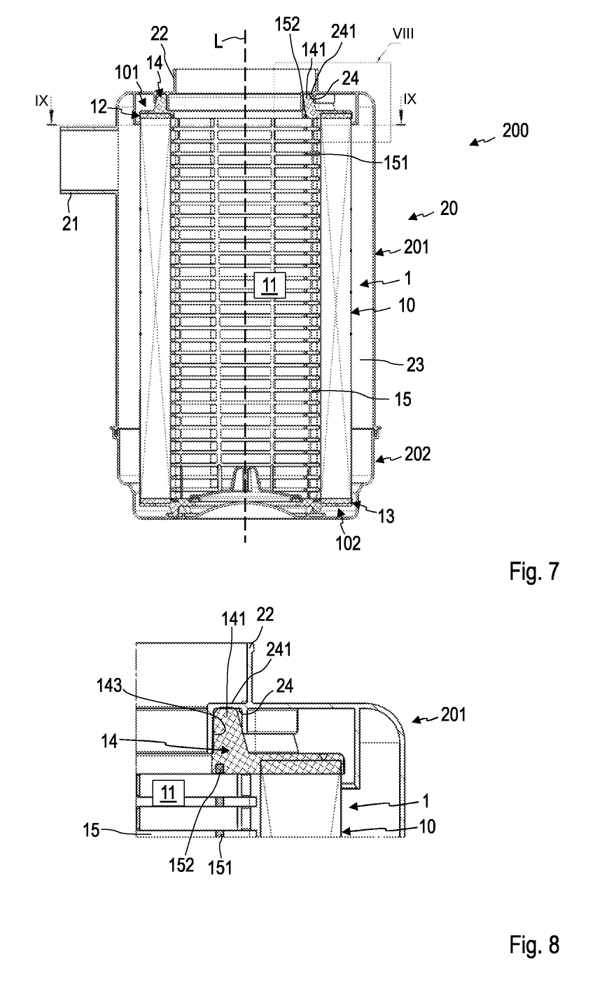

In the longitudinal sections of FIG. 7 and FIG. 8, the sealing action of the filter element 1 in relation to the filter housing 20, for example in relation to the first housing part 201, is illustrated in more detail. The first housing part 201 comprises near the fluid outlet 22 at least one circumferential housing seal surface 24 in which the circumferential seal contour 14 of the filter element 1 is received. The circumferential housing seal surface 24 has a locally limited recess which corresponds to the locally limited recess 141 of the circumferential seal contour 14 of the filter element 1. The housing seal surface 24 projects in the region of the locally limited recess at least in sections into a cross section of the fluid outlet 22. For example, the locally limited recess of the housing seal surface 24 is configured in this context at a protrusion 241 which for example may be one piece together with the first housing part 201. The housing seal surface 24 comprises for example a radially outwardly oriented circumferential radial seal surface at which the radial seal surface 143, embodied at an inner circumference of the circumferential seal contour 14 of the filter element 1, rests seal-tightly. The circumferential radial seal surface of the housing seal surface 24 which is oriented radially outwardly is for example formed at a circumferential seal wall which frames the circumferential seal contour 14 of the filter element 1 radially inwardly and circumferentially.

In FIG. 9 the structure of the filter bellows 10 as a folded filter is furthermore illustrated. The filter bellows 10 comprises a filter medium laid into folds 100, wherein the folds 100, viewed across the circumference, form a substantially star-shaped course. Furthermore, due to the position of the section plane IX-IX in FIG. 7 which sections the support grid 15 in the region of a stay which extends in normal direction to the longitudinal axis L, it may be seen that the bulge 151 of the support grid 15 may have a substantially circular arc-shaped configuration. The cross-sectional shape and cross-sectional dimensions of the bulge 151 correspond in this context, for example to the cross-sectional shape and cross-sectional dimensions of the locally limited recess 141 of the circumferential seal contour.

FIG. 10 shows an isometric view of the first filter housing part 201 of the filter device according to the invention according to the first embodiment. The first filter housing part 201 is for example a housing pot 201 with a receiving space 23 for the filter element 1. The housing seal surface 24 comprises a locally limited recess which corresponds to the locally limited recess 141 of the circumferential seal contour 14 of the filter element 1.

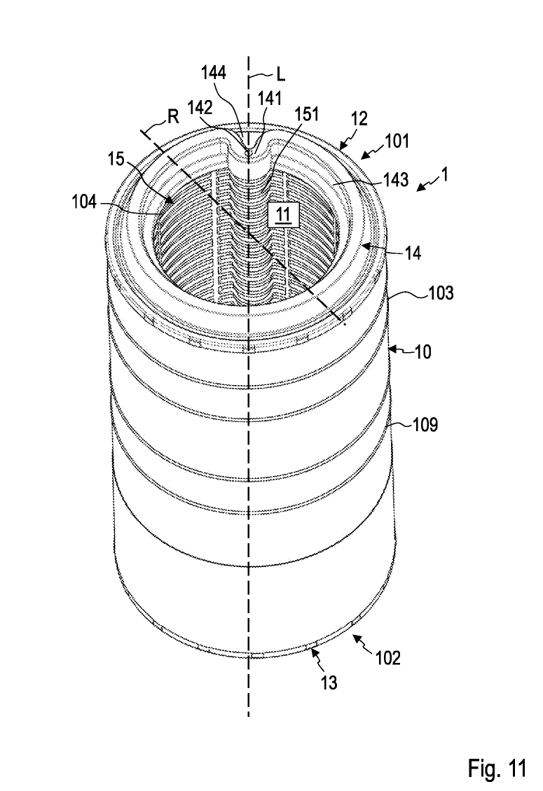

FIG. 11 shows an isometric view of a filter element 1 according to the invention according to a second embodiment which, with respect to its basic configuration, is very similar to the filter element 1 according to the first embodiment so that only the differences will be discussed.

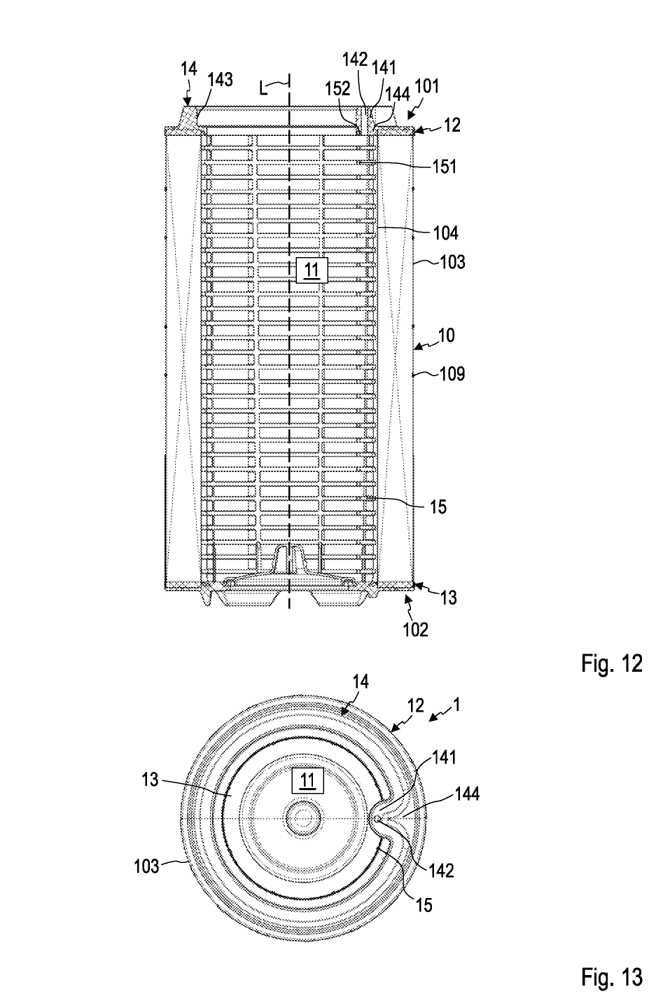

The end plate 12 open toward the interior 11 comprises in the region of the locally limited recess 141 an aperture 142 which passes with an axial component through the end plate 12 open toward the interior 11 so that the interior 11 via the aperture 142 is in fluid communication with an external space which is lying axially outside of the circumferential seal contour 14. The aperture 142 is positioned in this context at the circumferential seal contour 14 and extends with an axial component through the circumferential seal contour 14. The aperture 142 may extend, for example from an end face of the circumferential seal contour 14 completely through a material of the circumferential seal contour 14 so that a continuous fluid channel from the end face to the interior 11 is formed. This is more clearly illustrated in the longitudinal section of FIG. 12. The aperture 142 in relation to the radial direction R is for example positioned such that it opens radially inside of the inner circumference 104 of the filter bellows 10 into the interior 11.

A cross section of the fluid channel formed by the aperture 142 may be, for example circular which is illustrated in the plan view of FIG. 13.

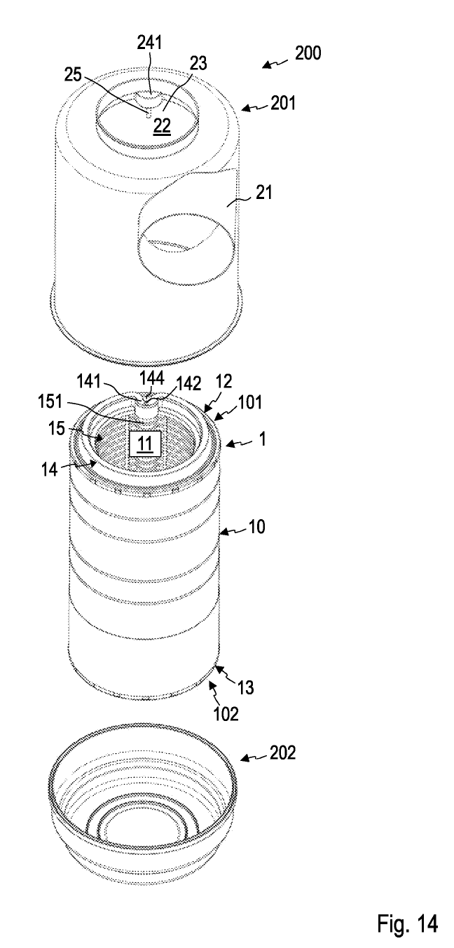

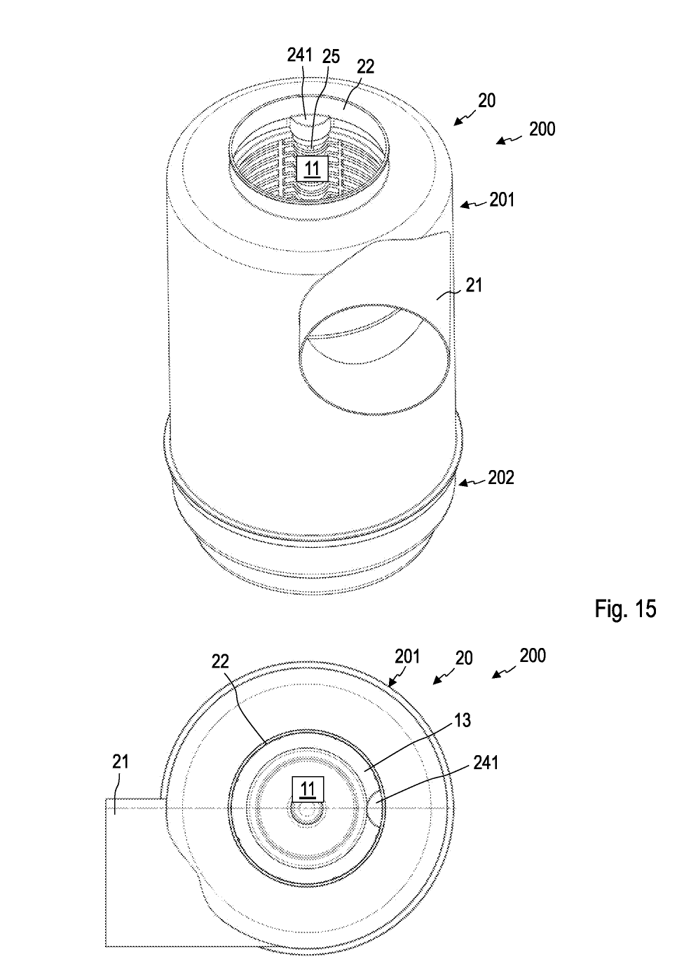

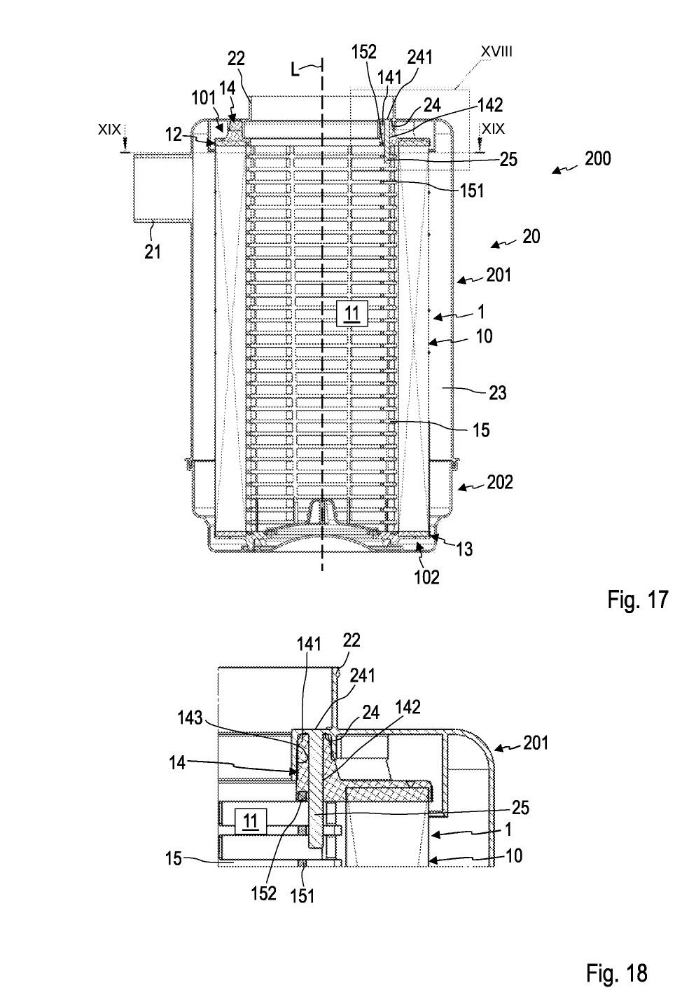

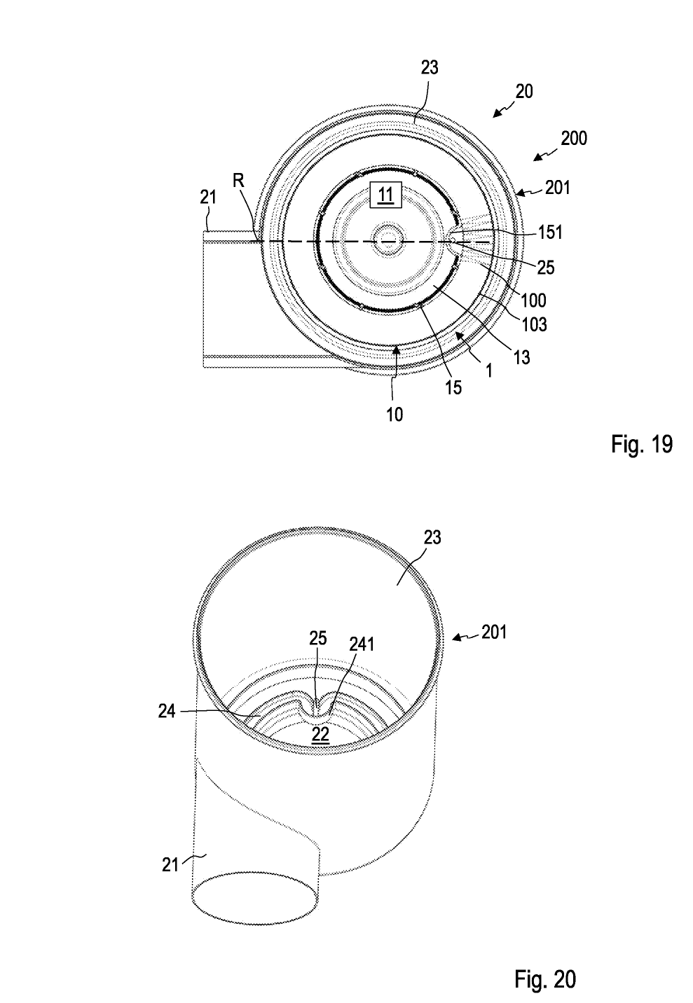

The filter housing 20, for example the first housing part 201, comprises at least one housing projection 25 which protrudes into the receiving space 23 and which may be received in the aperture 142 of the end plate 12 open toward the interior 11; this is illustrated in FIG. 14 and FIG. 20. The housing projection 25 is arranged at the housing seal surface 24 in the region of the locally limited recess of the housing seal surface 24. The housing projection 25 comprises for example an elongate, for example pin-shaped form. In a mounted state of the filter element 10 in the filter housing 20, the housing projection 25 projects at least in sections into the aperture 142 of the open end plate 12 of the filter element 1, which is illustrated in FIG. 17 and FIG. 18. The housing projection 25 extends for example completely through the aperture 142 of the circumferential seal contour 14 of the filter element 1 so that it exits again from the circumferential seal contour 14 in the region of the locally limited recess 141 at a backside of the circumferential seal contour 14 facing the interior 11 and projects into the interior 11; this is also visible in the section view of FIG. 19. The housing projection 25 in this context is arranged in relation to the radial direction R such that it protrudes into the interior 11 between the inner circumference 104 of the filter bellows 10 and the bulge 151 of the support grid 15.

In embodiments which are not illustrated, the protruding housing projection 25 at least in sections may be hollow and may be embodied as part of a pressure measuring device so that by means of the protruding housing projection 25 a pressure within the interior 11 of the filter element 1 may be tapped and may be made available to the pressure measuring device. In other words, the housing projection 25 hollow at least in sections may form part of a pressure measuring conduit of the pressure measuring device. In this way, it is, for example, possible to determine a pressure loss across the filter element 1, for example across the filter bellows 10 of the filter element 1, in order to derive conclusions in regard to a load state of the filter element 1.

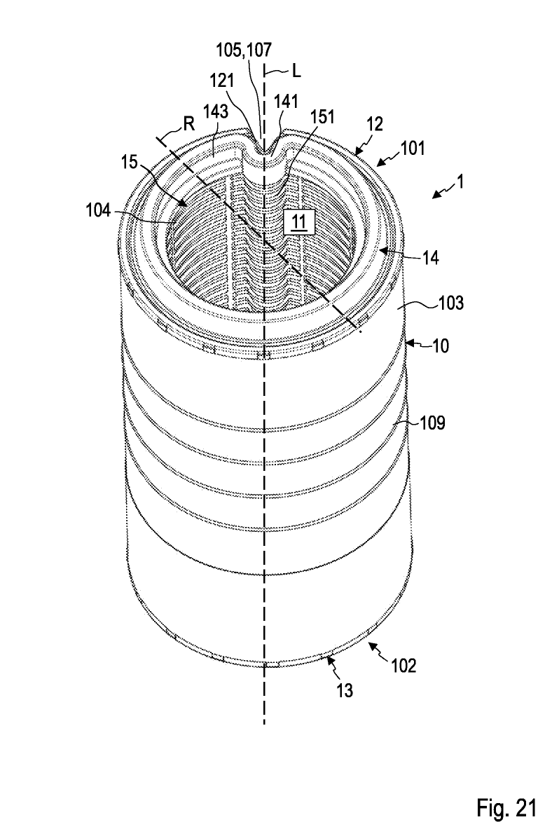

FIG. 21 shows an isometric view of a filter element 1 according to the invention according to a third embodiment which, with respect to its basic configuration, is very similar to the filter element 1 according to the first embodiment, so that only the differences will be discussed.

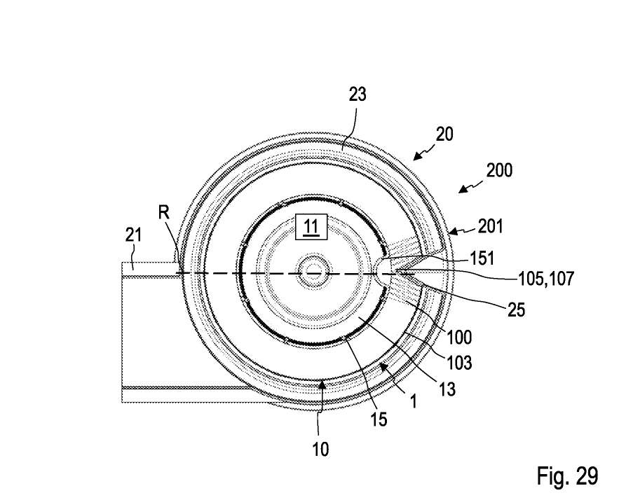

The filter bellows 10 comprises at its outer circumference 103 a notch 105. The circumferential seal contour 14 has in the region of the notch 105 at the outer circumference 103 of the filter bellows 10 a locally limited recess 141 in relation to the radial direction R, wherein the recess 141 of the seal contour 14 is arranged circumferentially such that its position corresponds to the circumferential position of the notch 105 at the outer circumference 103 of the filter bellows 10. The notch 105 at the outer circumference 103 of the filter bellows 10 is formed by a spread-apart portion 107 of at least one fold 100 of the filter bellows 10 at the outer circumference 103 (see FIG. 29). At least one fold 100 is widened in the region of the notch 105 provided by the spread-apart portion 107 at the outer circumference 103.

The end plate 12 open toward the interior 11 has a cut 121 at its outer circumference which corresponds to the notch 105 at the outer circumference 103 of the filter bellows 10 and is aligned with the notch 105. The cut 121 may be understood as a local material cutout of the open end plate 12 and extends from the outer circumference of the open end plate 12 with a radial component R inwardly. The cut 121 comprises two opposed cut walls which extend at, for example, an acute angle relative to each other.

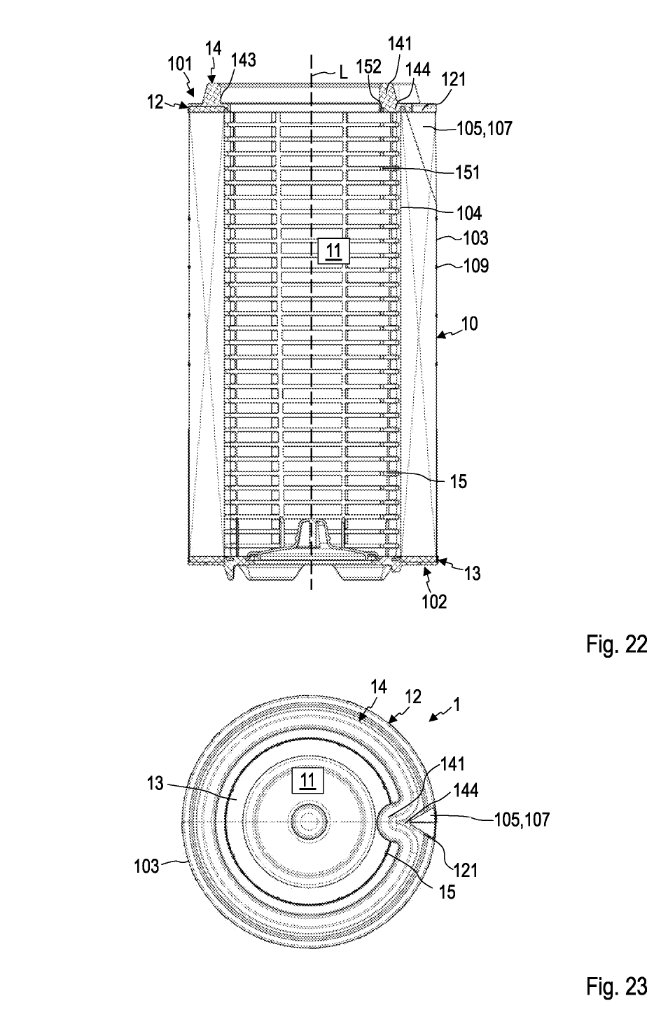

The notch 105 at the outer circumference 103 of the filter bellows 10 is positioned at the first end 101 of the filter bellows 10 and is shorter in the direction of the longitudinal axis L than the total extension of the filter bellows 10, for example, the notch 105 is present only at a longitudinal portion of the filter bellows 10 which is close to the first end 101. At a longitudinal portion of the filter bellows 10 remote from the first end 101, the notch 105 provided as a spread-apart portion 107 reverts to a uniform fold shape which corresponds to that of the plurality of the folds 100 of the filter bellows 10, which may be seen in FIG. 22 by means of the tapering structure of the spread-apart portion 107 in the direction of the second end 102.

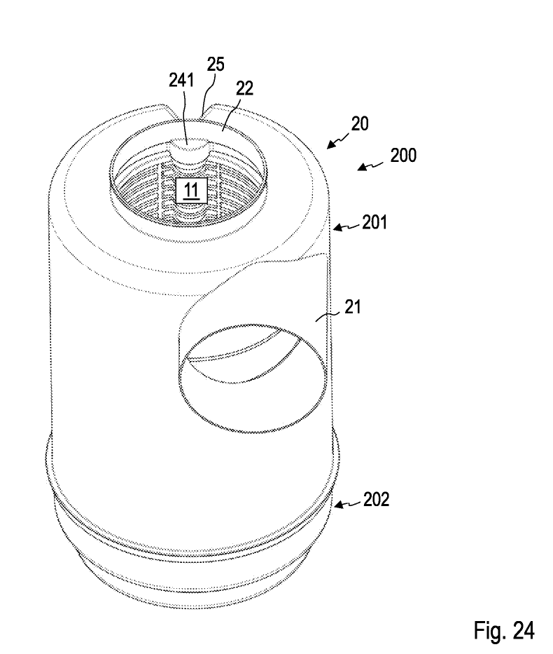

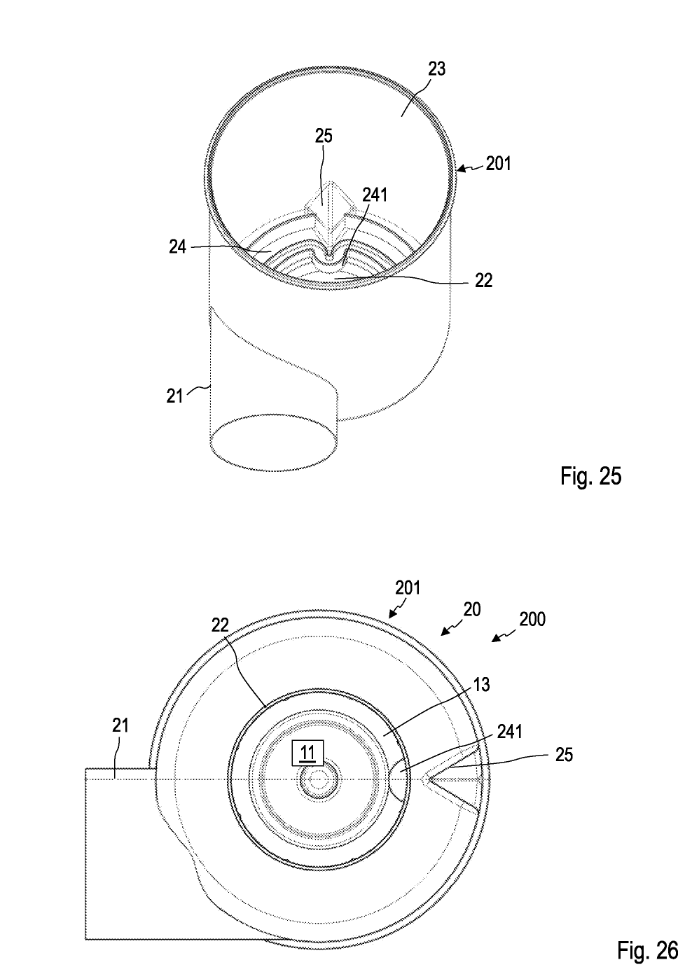

The filter housing 20, for example the first housing part 201, comprises a housing projection 25 protruding into the receiving space 23 which in the mounted state may be received in the notch 105 at the outer circumference 103 of the filter element 1, which provides an additional means for unequivocal angular positioning of the filter element 1 in the filter housing 20; this is illustrated in FIG. 24 to FIG. 26.

The housing projection 25 extends from an outer wall of the first housing part 201 with a radial component inwardly and comprises a predetermined extension in the direction of the longitudinal axis so that it may engage, through the cut 121 of the open end plate 12 of the filter element 1, the notch 105 at the outer circumference of the filter element 1 which is for example configured as a spread-apart portion 107. The housing projection 25 comprises two projection walls which are facing away from each other and which are positioned at an acute angle to each other so that a housing projection 25 with a triangular shape results as a whole, for example.

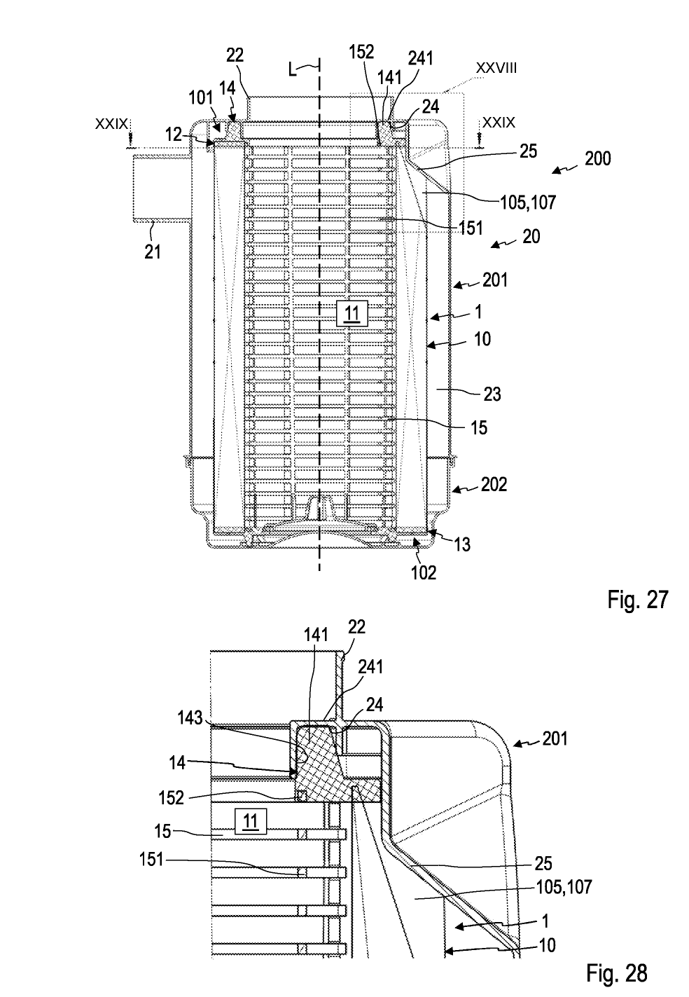

In FIGS. 27, 28 and 29, the engagement of the housing projection 25 through the cut 121 at the outer circumference of the open end plate 12 of the filter element 1 in the notch 105, for example embodied as a spread-apart portion 107, at the outer circumference 103 of the filter element 1 may be seen even more clearly.

In FIG. 29, the structure of the notch 105, formed as a spread-apart portion 107, at the outer circumference 103 of the filter element 1 is illustrated better still. The folds 100 of the filter bellows 101 are present in the form of star-shaped folds, wherein the folds 100 have a uniform cross sectional shape across a major portion of the circumference. In the region of the notch 105 at the outer circumference provided by the spread-apart portion 107, a fold 100 is widened which means that the distance of fold edges at the outer circumference adjoining a fold bottom or a fold top in relation to neighboring folds is enlarged so that the housing projection 25 may engage therein.

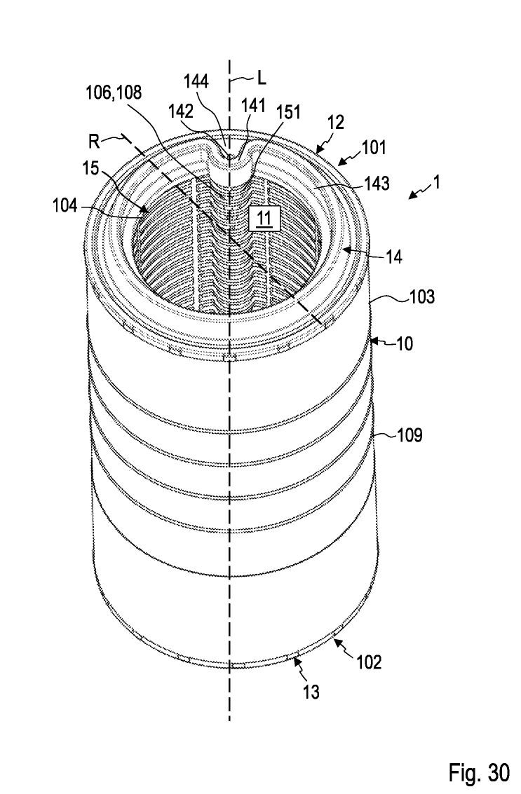

FIG. 30 shows an isometric view of a filter element 1 according to the invention according to a fourth embodiment which, with respect to its basic configuration, is very similar to the filter element 1 according to the first embodiment so that only the differences will be explained.

A region which is positioned radially outside of the locally limited recess 141 of the circumferential seal contour 14 is sealed in relation to the open end plate 12 and/or the filter bellows 10, wherein the region positioned radially outside of the locally limited recess 141 of the circumferential seal contour 14 is closed by an end wall 144 which is for example one piece together with the open end plate 12.

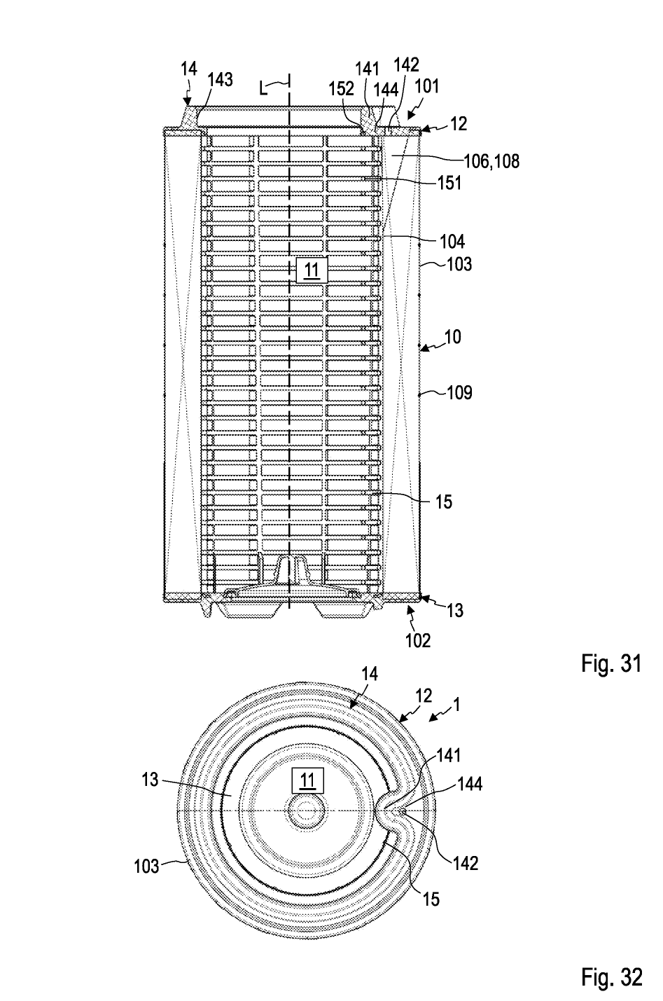

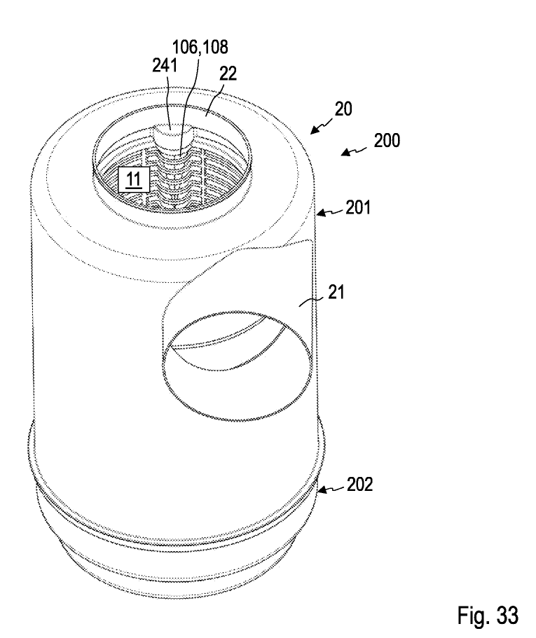

The end plate 12 open toward the interior 11 comprises in the region of the locally limited recess 141 an aperture 142 which passes through the end plate 12 open toward the interior 11 with an axial component so that the interior 11 by means of the aperture 142 is in fluid communication with an external space which lies axially outside of the open end plate 12. In this way, the aperture 142 is present at the end wall 144 and extends with an axial component through the end wall 144, wherein the aperture 142 connects the interior 11 in fluid communication to an external space lying axially outside of the end wall 144. The aperture 142 may extend for example from an end face of the end wall 144 completely through a material of the end wall 144 so that a continuous fluid channel is formed from the end face to the interior 11. This is once again illustrated in more detail in the longitudinal section of FIG. 31. The aperture 142 is positioned in relation to the radial direction R for example such that it opens radially outside of the inner circumference 104 of the filter bellows 10 in the interior 11, wherein the aperture 142 opens into the interior 11 for example in the region between two neighboring folds 100 of the filter bellows 10.

The cross section of the fluid channel which is formed by the aperture 142 may be, for example circular. which is illustrated in the plan view of FIG. 32.

Furthermore, at the inner circumference 104 of the filter bellows 10 a notch 106 is present, wherein the circumferential seal contour 14 in the region of the notch 106 has a locally limited recess 141 which is arranged circumferentially such that its position corresponds to a circumferential position of the notch 106 at the inner circumference 104 of the filter bellows 10.

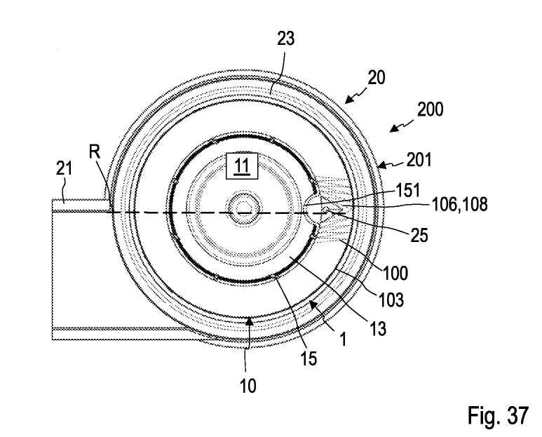

The notch 106 at the inner circumference 104 of the filter bellows 10 is formed by a spread-apart portion 108 of at least one fold 100 of the filter bellows 10 at the inner circumference 104 (see FIG. 37). The folds 100 of the filter bellows 10 have for example the form of star-shaped folds, wherein the folds across a major portion of the circumference have a uniform cross-sectional shape. In the region of the notch 106 provided by the spread-apart portion 108 at the inner circumference 104, at least one fold 100 is widened.

The notch 106 at the inner circumference 104 of the filter bellows 10 is positioned at the first end 101 of the filter bellows 10 and is shorter in the direction of the longitudinal axis L than the total extension of the filter bellows 10, for example the notch 106 is present only in a longitudinal portion of the filter bellows 10 which is close to the first end 101. In a longitudinal portion of the filter bellows 10 remote from the first end 101, the notch 106 provided as a spread-apart portion 108 reverts to a uniform fold shape which corresponds to that of the plurality of the folds 100 of the filter bellows 10, which may be seen in FIG. 31 by means of the tapering structure of the spread-apart portion 108 in the direction of the second end 102.

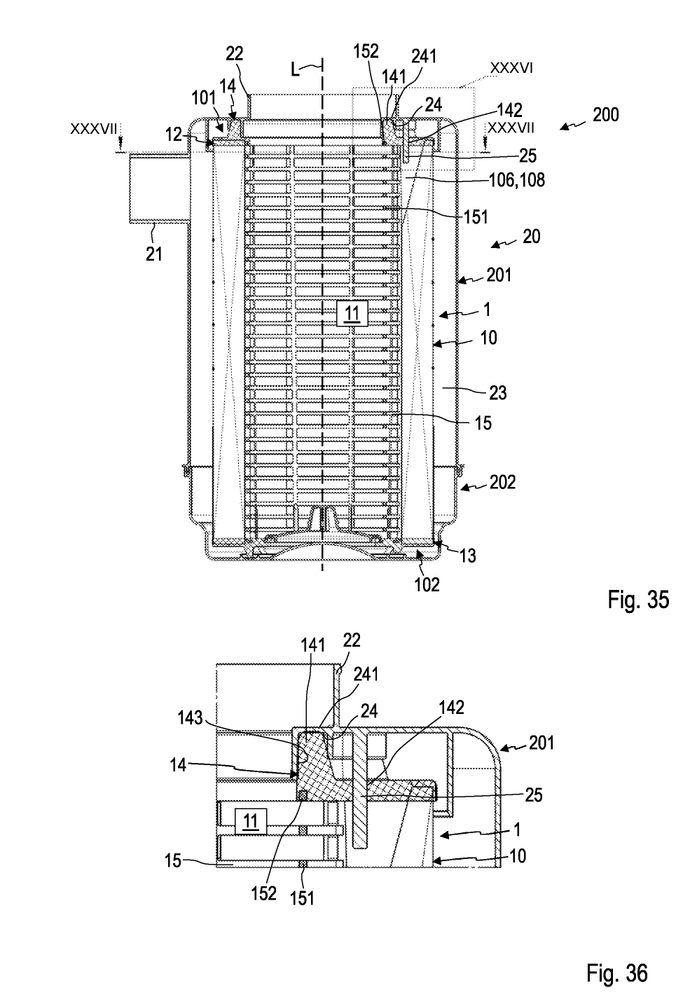

The notch 106 at the inner circumference 104 of the filter bellows 10 represents for example a receiving space within the filter bellows 10 in which the housing projection 25 projecting through the aperture 142 may be received, which is illustrated in FIG. 35 and FIG. 36.

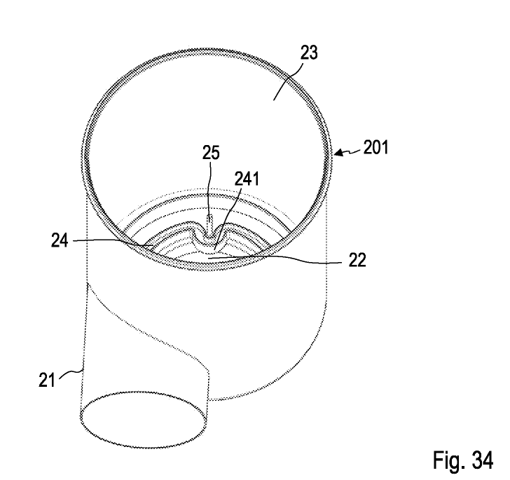

The housing projection 25 of the filter housing 20 projecting into the receiving space 23, for example of the first housing part 201, is arranged in the region of the locally limited recess of the housing seal surface 24 radially outside of the housing seal surface 24, which is illustrated in FIG. 34. The housing projection 25 comprises for example an elongate, for example pin-type, form.

### REFERENCE CHARACTERS

1 filter element

10 filter bellows

11 interior

12 end plate open toward the interior

13 further end plate, for example closed end plate

14 circumferential seal contour

15 support grid

20 filter housing

21 fluid inlet

22 fluid outlet

23 receiving space

24 housing seal surface

25 housing projection

100 folds

101 end face first end

102 end face second end

103 outer circumference

104 inner circumference

105 notch at the outer circumference

106 notch at the inner circumference

107 spread-apart portion at the outer circumference

108 spread-apart portion at the inner circumference

109 fold stabilization means

121 cut

141 recess of the circumferential seal contour

142 aperture

143 radial seal surface

144 end wall

151 bulge

152 end section

200 filter device

201 housing pot

202 housing cover

241 protrusion

L longitudinal axis

R radial direction

Which is claimed is:

1. A filter element comprising:
a filter bellows arranged around a longitudinal axis in a circumferential direction and enclosing an interior at least partially;
wherein the filter bellows comprises a first end at a first end face and a second end at an oppositely positioned second end face;
wherein the filter bellows comprises a first end plate open toward the interior arranged at the first end and a second end plate arranged at the oppositely positioned second end;
at least one circumferential seal contour arranged at the first end plate and rising in a direction of the longitudinal axis from the first end plate;
wherein the at least one circumferential seal contour comprises a locally limited recess in relation to a radial direction, wherein the at least one circumferential seal contour in a region of the locally limited recess protrudes radially inwardly past an inner circumference of the filter bellows.

2. The filter element according to claim 1, wherein the filter bellows comprises an inner wall surface adjoining the interior, wherein the at least one circumferential seal contour in the region of the locally limited recess extends radially inside of the inner wall surface of the filter bellows.

3. The filter element according to claim 1, further comprising a fluid-permeable support grid arranged in the interior, wherein the fluid-permeable support grid supports the filter bellows at an inner wall surface thereof.

4. The filter element according to claim 3, wherein the fluid-permeable support grid comprises an end section at an end thereof adjacent to the first end of the filter bellows, wherein the end section supports the at least one circumferential seal contour in the region of the locally limited recess.

5. The filter element according to claim 4, wherein the end section is embedded in the region of the locally limited recess in the at least one circumferential seal contour.

6. The filter element according to claim 3, wherein the fluid-permeable support grid comprises at least one locally limited bulge in relation to the radial direction, wherein the at least one locally limited bulge protrudes into the interior, wherein the at least one locally limited bulge is arranged in the circumferential direction such that a circumferential position of the at least one locally limited bulge corresponds to a circumferential position of the locally limited recess of the at least one circumferential seal contour.

7. The filter element according to claim 6, wherein the at least one locally limited bulge protrudes farther into the interior than a major portion of a circumference of the fluid-permeable support grid.

8. The filter element according to claim 1, wherein a region positioned radially outside of the locally limited recess of the at least one circumferential seal contour is sealed in relation to the first end plate and/or the filter bellows.

9. The filter element according to claim 8, wherein the region positioned radially outside of the locally limited recess of the at least one circumferential seal contour is closed by an end wall, wherein the end wall is configured as one piece together with the first end plate.

10. The filter element according to claim 1, wherein the first end plate, in the region of the locally limited recess, comprises at least one aperture passing with an axial component through the first end plate, wherein the at least one aperture connects in fluid communication the interior to an external space located axially outside of the first end plate.

11. The filter element according to claim 10, wherein the at least one aperture is present at the at least one circumferential seal contour and passes with an axial component through the at least one circumferential seal contour, wherein the at least one aperture connects in fluid communication the interior to an external space located axially outside of the at least one circumferential seal contour.

12. The filter element according to claim 10, wherein a region positioned radially outside of the locally limited recess of the at least one circumferential seal contour is closed by an end wall, wherein the end wall is configured as one piece together with the first end plate, wherein the at least one aperture is present at the end wall and passes with an axial component through the end wall, wherein the at least one aperture connects in fluid communication the interior to an external space located axially outside of the end wall.

13. The filter element according to claim 1, wherein the filter bellows comprises at least one notch arranged at an outer circumference thereof and/or at the inner circumference thereof, wherein the at least one notch is arranged in the circumferential direction such that a circumferential position thereof corresponds to a circumferential position of the locally limited recess of the at least one circumferential seal contour.

14. The filter element according to claim 13, wherein the at least one notch is formed by at least one spread-apart portion of at least one fold of the filter bellows at the inner circumference and/or at the outer circumference.

15. The filter element according to claim 1, wherein the at least one circumferential seal contour has a circular shape and wherein a circumferential course of the at least one circumferential seal contour in the region of the locally limited recess deviates from the circular shape.

16. The filter element according to claim 1, wherein the at least one circumferential seal contour comprises at least one circumferential radial seal surface.

17. A filter device comprising:
a filter housing comprising a fluid inlet, a fluid outlet, and a filter element receiving space;
a filter element according to claim 1 arranged in the filter element receiving space such that a raw side correlated with the fluid inlet is separated from a clean side correlated with the fluid outlet.

18. The filter device according to claim 17, wherein the filter housing comprises at least one circumferential housing seal surface, wherein the at least one circumferential seal contour of the filter element rests against the at least one circumferential housing seal surface, wherein the at least one housing seal surface comprises a locally limited recess corresponding to the locally limited recess of the at least one circumferential seal contour of the filter element.

19. The filter device according to claim 18, wherein the first end plate of the filter element, in the region of the locally limited recess, comprises at least one aperture passing with an axial component through the first end plate, wherein the at least one aperture connects in fluid communication the interior to an external space located axially outside of the first end plate, wherein the filter housing comprises at least one housing projection protruding into the receiving space and being received in the at least one aperture of the first end plate.

20. The filter device according to claim 19, wherein the at least one housing projection is hollow at least in sections and is configured as part of a pressure measuring device, wherein tapping of a pressure in the interior of the filter element is possible through the at least one housing projection.
